(19) United States
(12) Patent Application Publication
(10) Pub. No.: US 2016/0193935 A1
(43) Pub. Date: Jul. 7, 2016

(54) Advances in Electric Car Technology

(71) Applicant: Catalin TUTUNARU, Cape Elizabeth, ME (US)

(72) Inventor: Catalin TUTUNARU, Cape Elizabeth, ME (US)

(73) Assignee: H&D ELECTRIC, LLC, Baltimore, MD (US)

(21) Appl. No.: 14/654,192

(22) PCT Filed: Dec. 23, 2013
(86) PCT No.: PCT/US13/00281

§ 371 Date: Jun. 19, 2015

Related U.S. Application Data
(60) Provisional application No. 61/848,164, filed on Dec. 24, 2012.

(51) Int. Cl. B60L 11/18; H01M 10/36; H01M 4/58; H01M 4/62; H02K 1/27; F03D 3/00; F03D 3/04; F03D 9/00; H01M 10/44; H01M 10/42

(52) U.S. Cl. CPC B60L 11/1851; H01M 10/441; H01M 10/36; H01M 4/582; H01M 10/425; B60L 11/1809; H02K 1/2793; B60L 11/1853; B60L 11/1861; B60L 11/1864; B60L 11/1879; F03D 3/005; F03D 3/0427; F03D 9/002; H01M 4/626; H01M 2220/20; H01M 2010/4271

(57) ABSTRACT

System for managing the charge on an electrical storage battery so as to extend its useful life between charges, and providing enhanced safety features.

This application is entitled to and claims priority from U.S. Provisional Application 61/848,164, filed on Dec. 24, 2012, which is incorporated herein by reference.

### FIELD AND BACKGROUND OF THE INVENTION

1. Field of the Invention

The present invention relates in general to electric cars, including the field of electrical storage batteries, a novel system for providing an electrical storage battery with enhanced safety features and systems for improving the range of a vehicle powered by the novel system.

2. Background Information

The invention described and claimed herein comprises a number of advances in electric car technology, including a novel system for managing the charge on an electrical storage battery so as to extend its useful life between charges, a novel system for providing an electrical storage battery with enhanced safety features and additional systems for improving the range of a vehicle powered by the novel system.

Rechargeable batteries include an anode, a cathode and a chamber within which chemicals are stored, and operate by charging and discharging. During the charging phase, current is passed through the battery's anode and cathode in order to promote a chemical reaction in the chemical storage chamber, which results in storage of power; during the discharge phase, a second chemical reaction takes place in the chemical storage chamber which results in the production of an electric current from the cathode to the anode, typically through a circuit which harnesses the electrical current to do work.

It is generally undesirable to fully discharge a battery. Thus only a fraction of the stored energy may be harnessed to do useful work before it is necessary to charge the battery. The greater the capturable fraction, the longer the battery can operate between recharging.

In some applications, extending this period between recharges can make the difference between a useful product and one with limited uses. For example, development of the electric car industry has been hampered by the lack of sufficient charging stations nationwide, limiting the usefulness of electric cars to applications which require a range comfortably within the distance between recharging stations. For example, if a car battery could operate 85 miles between charges would be suitable for a commuter with a recharging station at home and a 25 mile one-way commute, but would not be suitable for one with a 50 mile one-way commute or for a 100 mile weekend trip.

One solution to this problem has been the creation of hybrid vehicles, such as the Toyota Prius™, which use battery power for a portion of the time but which also can be powered by gasoline if necessary. A 100% electric vehicle, however, is preferable to a hybrid vehicle, because it is a clean air motor with no emissions and lower noise level. Another reason to have a 100% electric is due to its simplicity compared to a hybrid vehicle where the gas and/or diesel powered engine is more costly, uses a significant amount of metal, and a costly emission system, including catalytic. For the electric motor you do not have fuel filters, air filters, and all other accessories, which in regards to production are more costly, and will pollute the atmosphere and/or our forests [use of paper for filters].

In addition, while the materials used in batteries are safe while contained within the battery enclosure they may pose hazards if the enclosure is compromised. For example, a typical battery contains acid and elements which are considered hazardous waste, and dangerous if they spill because of the crash test.

In addition, while the electrical energy of a battery is typically connected to a circuit which provides for safe use of the current provided by the battery, a short-circuit of the battery terminals poses a risk of fire or explosion; the novel system reduces that risk.

At particular risk are batteries used in automobiles, which are subject to compromise under the extreme conditions of a collision, which may involve high energy impact or high temperatures if the gasoline in the vehicle catches fire.

### SUMMARY OF THE INVENTION

It would therefore be an advantage to provide a pure electric vehicle, capable of a range comparable to gasoline-powered vehicles.

One step in that direction would be a management system which would increase the percentage of the stored energy which could be extracted from a battery before the need for recharging or to provide regeneration sources, thereby increasing the life of a battery between charges. It is an object of the invention to increase the percentage of the stored energy which could be extracted from a battery before the need for recharging and to extend the range of a vehicle using battery power.

It would also be an advantage to provide an electric battery having safety features which would reduce the risk of escape of hazardous elements or fire or explosion in the event the battery is subjected to impact or high temperatures. It is therefore an additional object of the invention to increase safety.

### BRIEF DESCRIPTION OF THE DRAWINGS

The foregoing and still other objects of this invention will become apparent, along with various advantages and features of novelty residing in the present embodiments, from study of the following drawings, in which:

FIGS. 1-3 are an overview of the system.

FIG. 4 is a flow chart showing the steps carried out by the controller.

FIG. 5 shows representative temperature ranges for operation, under the control of the controller.

FIG. 6 shows a typical cell.

FIG. 7 is a perspective view showing a configuration of a two-bank battery system.

FIG. 8 illustrates details of a buss connection between cells.

FIG. 9 is another view of a configuration of a two-bank battery system, showing an external connector and heater.

FIGS. 10-12 are views of an enhanced torque motor.

FIGS. 13 and 14 show the wiring for the enhanced torque motor.

FIGS. 15-16 show the arrangement of magnets in the enhanced torque motor.

FIGS. 17-19 show a suitable configuration of a venturi tube and fan, including details of the fan blades.

### DESCRIPTION OF THE PREFERRED EMBODIMENT

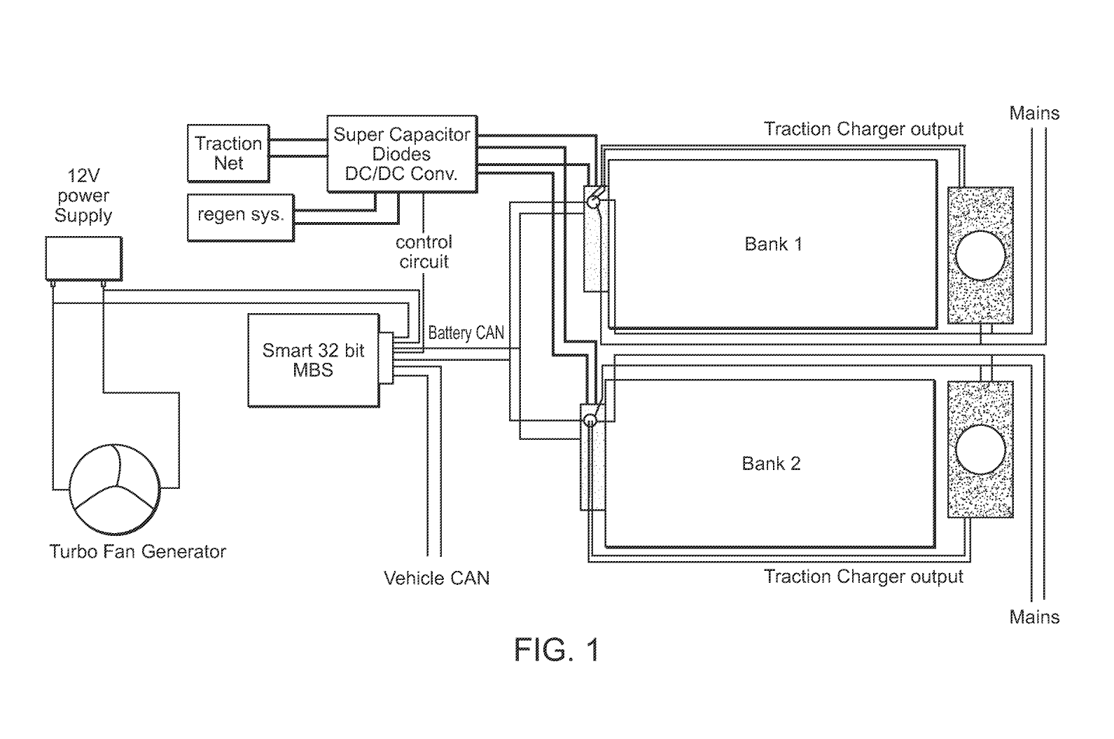

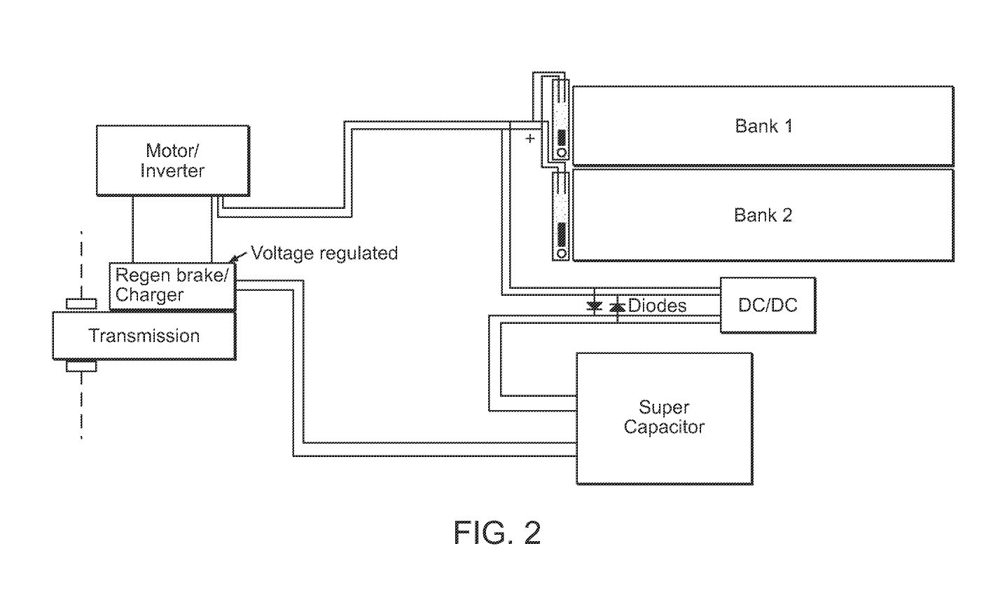

Referring to the drawings, the invention is a novel system for managing and supplementing the charge on an electrical storage battery and managing the method of delivery and application of power so as to extend its useful life between charges, shown in overview in FIGS. 1-3.

While illustrated with respect to use in an electric vehicle, the invention may be applied to any device requiring battery power, using the same techniques, modified in a manner which would be known to one skilled in the art. As an example, and not intended as a limitation, the disclosure could be modified and applied to Nano batteris using techniques known to those of skill in the art.

### BATTERY MANAGEMENT

In a typical electric powered motor vehicle, power is drawn from a battery to power the vehicle and the battery is recharged to some extent during operation using regenerative braking. Regenerative braking is not sufficient to fully recharge the battery, so periodically the battery must be connected to a source of electricity and recharged. That process typically takes from 4 to 8 hours during which time the car cannot be used for transportation. There are special charging stations which can charge a battery in 30 minutes but these shorten the life of the battery considerably.

Typically, once the battery has been drawn down to 20% it must be recharged because the power of the motor will go to max 40%. A delay in recharging the battery will also result.

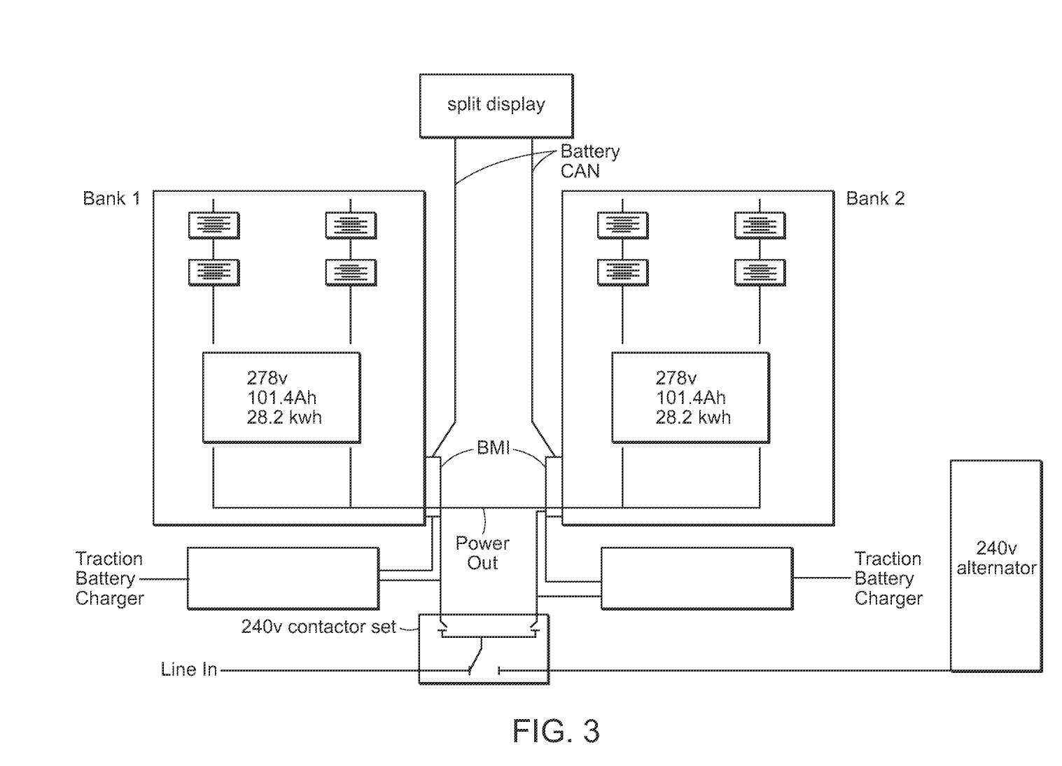

In the system claimed herein, a battery similar in capacity is divided into segments as shown in FIG. 3. For simplicity, the system is illustrated with two segments. Each segment comprises a bank of one or more cells connected to achieve the desired voltage; optionally, multiple banks may be connected in parallel to provide redundancy.

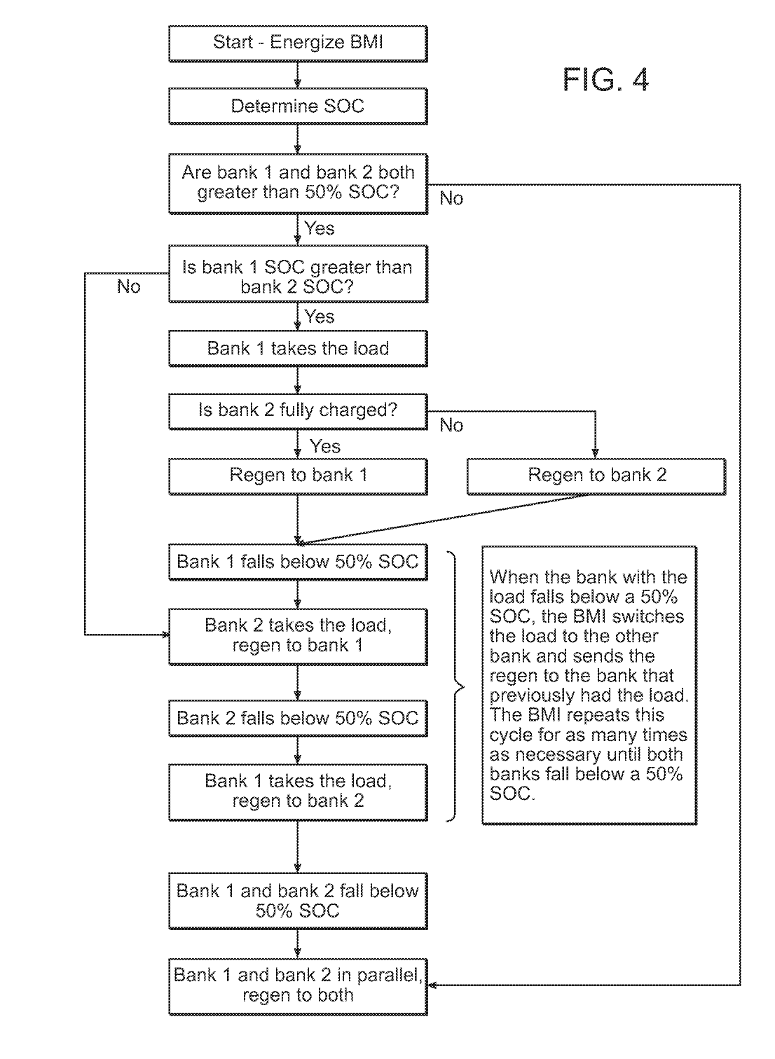

The operation of the Battery Management Interface (BMI), which controls selection of the segments for charging or traction (providing power to propel the vehicle) is shown in the flowchart in FIG. 4.

The controller monitors the level of charge in each bank. For simplicity of explanation, the banks are referred to as Bank 1 and Bank 2. Initially, power is drawn from Bank 1. At the point when Bank 1 has be drawn down to 50%, the controller switches power from Bank 1 to Bank 2 (which is 100% charged), drawing power now from Bank 2 and using such recharging capacity as may be available (for example, from regenerative braking) to recharge Bank 1. At the point when Bank 2 reaches 50% charge, present value. The controller switches power back to Bank 1, drawing power now from Bank 1 and using such recharging capacity as maybe available to recharge Bank 2. This process of monitoring and switching continues until both Banks reach a critical value, at which point the battery which is formed out of Bank 1 and Bank 2 must be completely recharged.

The dual bank battery produces the necessary energy to power and cover the requested operation needs. Because of variations in energy consumption due to the drive cycles and battery aging, the BMI will normally not allow the State of Charge (“SOC”) to fall below 20%. If the SOC falls below 20%, the vehicle can still be operated in an emergency situation at a reduced level of performance until the battery is fully discharged.

The battery management interface (BMI) system is designed to switch between banks in a two bank battery system. The BMI switches batteries based on their state of charge (SOC). The battery that has the load (the “traction” battery) will increase in temperature as it is discharged. As the temperature of the battery with the load goes up, it discharges more quickly. The other battery (either charged or receiving the regen) is maintained between 245-285C. When the battery with the load drops below 50% SOC, the BMI switches the load to the other battery and sends all of the regen to the battery that had the load. While taking the regen, the battery is allowed to cool down. When the battery with the load falls to 50% SOC, the switch occurs again. Because the battery taking the regen won't reach 100% before the battery with the load falls to 50%, the batteries will continue to switch back and forth and their SOC will both fall until they both are at 50%.

Once both batteries are at 50%, the BMI puts the batteries in parallel and sends the regen to both. The batteries operate this way until the vehicle is charged again. If the chemical reactions in the battery are insufficient to maintain a minimum of 245C, the BMI increases battery activity so as to maintain 245c.

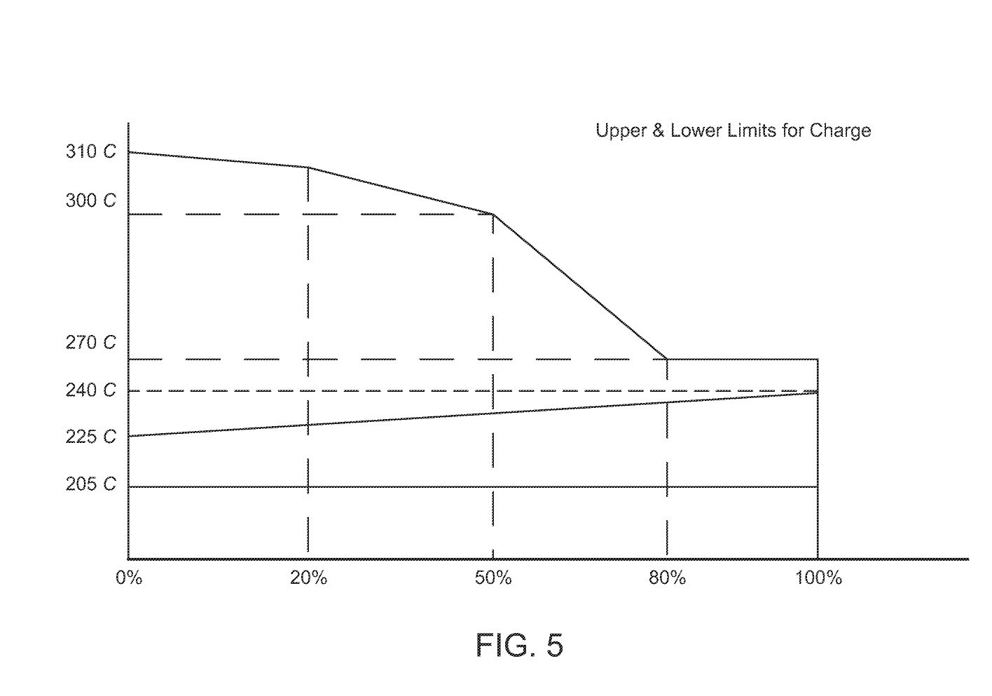

This battery switching increases range because a battery generates heat when it is being discharged, which causes the charge to go down more quickly. By switching back and forth, while one battery is discharging and driving the vehicle (the “traction battery”), the other one is being cooled or maintained at 245C. By switching back and forth, the battery being used is cooler that it would have been without the switching system, which makes the charge last longer. While being regenerated a battery is regulated to a lower current flow than when in operation and therefore the cooling system can reduce its temperature. The regen system acting on the battery doesn't cause any increase in battery temperature, so the BMI will cool the battery being charged to 245C and then complete a certain amount of chemical reactions within the battery to maintain 245C. Representative temperature ranges are shown in FIG. 5.

The benefit of this system over prior art single bank batteries is that it delays the point at which the battery reaches the critical value and thereby provides longer battery life between recharges. In the case of an electric vehicle, this translates into greater range and therefore greater usefulness of the vehicle. In case of an emergency, or need of additional power, the controller can switch to a position allowing the use of both Bank 1 and Bank 2 combined.

### BATTERY CONSTRUCTION AND CHEMISTRY

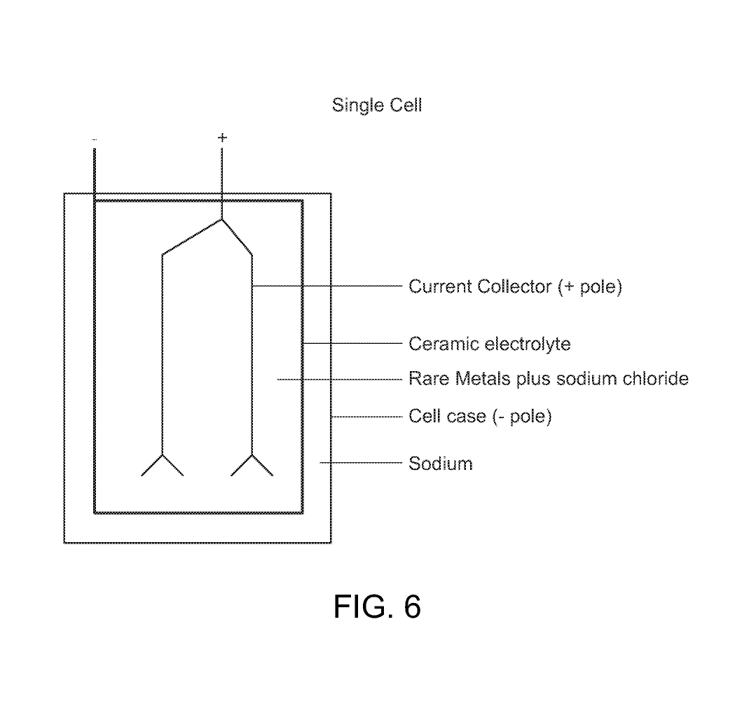

One type of battery which has been found to be particularly suited to powering an electric vehicle is made up of battery cells constructed as follows. Each battery cell, shown in FIG. 6, comprises a cell case acting as the negative pole, a layer of sodium, a ceramic electrolyte, sodium chloride and miscellaneous components (including iodine in a preferred embodiment) and a current collector acting as the positive pole.

The battery cell uses Sodium salt (NaCl), labeled as “Sodium” in FIG. 6, as the negative electrode. The salt used may contain iodine to increase the chemical reactions in the battery but should otherwise contain as few impurities as possible to avoid side reactions in the battery that can reduce its efficiency. Multiple salts with varying levels of iodine were tested in developing the battery chemistry. The preferred embodiment contains approximately 80 micrograms of iodine per gram of salt in the negative electrode and the iodine is preferably homogeneously distributed throughout the NaCl crystals. It is desirable that the salt crystals be uniform so as to avoid uneven power or temperature generation. The uniform size is needed because large crystals heats differently than a smaller crystals and variations in crystal size would cause variations in heat within the cell. Therefore, the salt crystals preferably should be uniform in size. It is also desirable to pack as much salt as possible into the battery. Therefore, as jagged NaCl crystals appear to permit more salt to be packed into the battery than do square-edged salt, the crystals are preferably uniformly jagged. Smaller salt crystals increase in surface area of the salt and also increase the speed of the chemical reactions. Using crystals that are too large, however, can decrease the cell performance. The salt in the preferred embodiment is approximately 1.5×1.5×2 mm and a formula of 38% salt (NaCl), 15% zinc (Zn), 16% copper (Cu), 18% iron (Fe), 4% silver (Ag), 5% nickel (Ni), and 4% miscellaneous was found to be suitable. Preferably the salt comprises NaCl with approximately 80 micrograms of iodine (I) per gram of salt. The 4% miscellaneous comprises Sodium Aluminum Tetrachloride (NaAlCl4), Mica, Silica Amorphous (SiO2), and Sulfide. The battery cell uses zinc and nickel chloride as the positive electrode. The positive electrode, labeled “Current Collector (+pole)” in FIG. 6, is a two pronged connector inside the ceramic electrolyte tube, labeled “Ceramic electrolyte” in FIG. 6. The two prongs and the additional extensions at the end of each prong of the collector increases the efficiency of the battery by creating a more uniform chemical reaction. When the battery is charged, the salt and metals are converted into metal chloride in the positive electrode and liquid sodium at the negative electrode. When the battery is discharged, the chemical process occurs in the reverse direction and the sodium reacts with the metal chloride in the positive electrode. The electrolyte (sodium chloroaluminate) conducts sodium ions and allows the sodium ions to move from the solid metal chloride electrode to and from the ceramic electrolyte. The ceramic electrolyte is sized to facilitate the installation of the cells in the dual bank arrangement and it also determines the resistance and efficiency of the cells. The ceramic electrolyte is commercially sourced, but it must be nonporous, uniform in shape (cylindrical) and be able to withstand the temperatures of the chemical reactions without melting.

The melting point of the salt used in the cells is 145° C., which requires a minimum battery operating temperature of 240° C. and optimal performance between 270° C. and 300° C. In this optimal temperature range, the positive electrode (beta alumina) also has a low electrical resistance which increases efficiency.

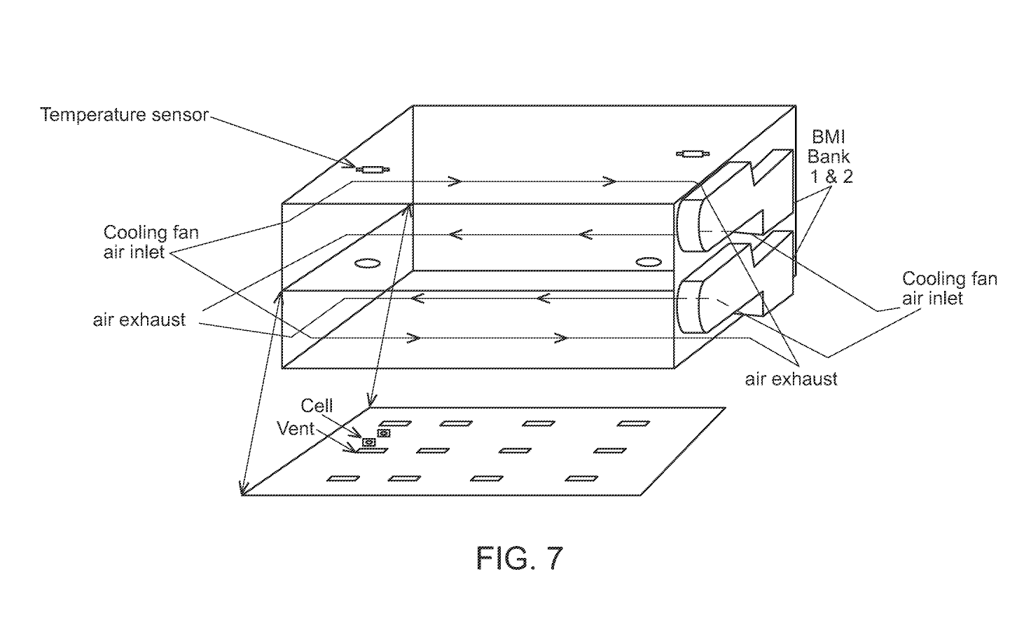

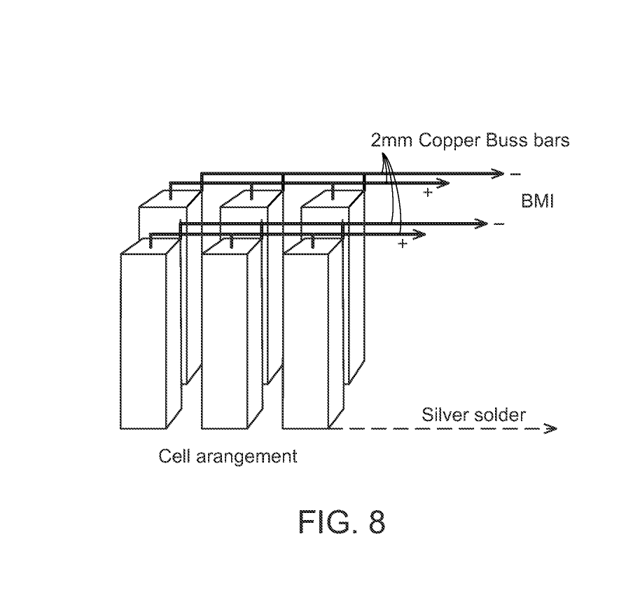

The battery cells are arranged in two banks within the battery. The two bank arrangement in the preferred embodiment uses an upper and a lower bank, which can be seen in FIG. 7. The individual cells are wired to produce the desired voltage needed to power the vehicle. Optionally, multiple banks may be connected in parallel to provide redundancy. The battery in the preferred embodiment is wired to produce 278V, 56.4K wh and 152 Ah and operates between 240° C. and 310° C. The battery cells are wired to produce the desired voltage and the two banks are connected in parallel and controlled by the BMI. As shown in FIG. 8, the cells are silver soldered to a base and the tops of the cells are supported by buss bars. In the upper and lower battery bank arrangement in the preferred embodiment, the battery cells in the lower bank are silver soldered directly to the bottom of the battery case. Between the upper and lower banks is a separator plate that separates the upper bank from the lower bank. The separator plate has ventilation slots in it to allow air to vent between the upper and lower bank. The separator plate supports the cells in the upper bank and they are silver soldered to the top surface of the separator plate. The position of the cells in relation to the vents on the separator plate is shown in FIG. 7.

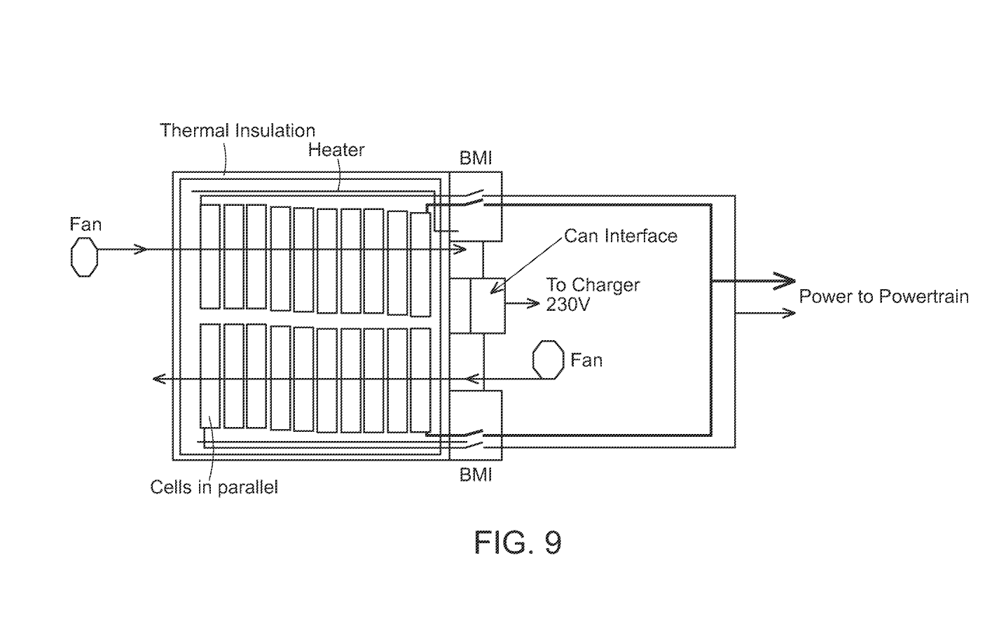

To keep the battery operating within its optimal temperature range of 270° C. and 300° C., the battery is enclosed in a double walled vacuum insulated box. In the preferred embodiment, SiO2 foam is used as the insulating material because it acts as a good insulator and can withstand temperatures of up to 1,000° C. When the powertrain system is energized, the chemical reactions in the battery cells produce heat to keep the battery above its minimum operating temperature of 240° C. If the battery bank is under a light load or receiving the regen, the BMI will have the battery complete enough chemical reactions to maintain 240° C. When the battery is plugged into an external power source, the minimum battery temperature is maintained by two ohmic (resistance) heaters, labeled “Heater” in FIG. 9, inside the battery box and controlled by the BMI.

### BATTERY COOLING SYSTEM

When discharging, the chemical reactions in the battery cells cause the bank in use to increase in temperature. To keep the battery banks within their optimal temperature range, the battery is air cooled using a multiple fan system. A multiple fan system is used to reduce the possibility of uneven cooling and hot spots that can occur in one fan cooling systems. In the preferred embodiment, one fan is used to cool each bank of batteries. The cooling fans are mounted remotely and connected with tubes. The battery mounting racks do not create an air tight seal between the banks, allowing the pressure to equalize between the banks. The mounting racks do, however, block the majority of the cooling air to cross from one bank to the other and direct the airflow through the battery as shown in FIG. 7. The battery case has one air inlet on either side and one air exhaust outlet on either side. In the preferred embodiment, high power, variable speed fans are mounted remotely to draw in cool air. Each fan supplies air to one air inlet through a tube. The cooling air enters the battery box through the air inlet and travels around and through the battery cells. Once the cooling air reaches the side opposite the inlet it entered, the air exits the battery box through an exhaust outlet. The air from the exhaust outlets is drawn away from the battery using tubes. The air inlet for bank one is mounted on the same side of the battery as the air exhaust outlet for bank two and the air inlet for bank two is mounted on the same side of the battery as the air exhaust outlet for bank one. This arrangement causes the cooling air to flow in opposite directions in bank one and bank two. The opposite flow is important because as the air travels through the bank, it heats up. When the cooling air is closest to the exhaust outlet, it is at its hottest. The vents in the separator plate allow the cool air from the air intake of the other bank to mix with the hot air near the exhaust outlet, stabilizing the temperature across all of the cells.

The BMI controls the cooling fans and receives battery heat information from four temperature sensors mounted in the top of each bank (2 per bank and shown in FIG. 7). The fans are activated based on the programing in the BMI based on temperature and SOC. The fans are generally activated by the BMI when the battery is between 250° C. to 270° C. Generally, if the SOC is higher than 80% and the battery temperature is at 270° C., the fans are not energized. Using this cooling system, the battery can operate safely.

### BATTERY SAFETY

There are several ways in which electric battery construction may be improved to accomplish these objectives, for example by using non-flammable elements, by providing insulation, by providing a closed vacuum box for containing the battery and by providing connectors between battery cells which melt or otherwise disconnect over the normal limits of accepted temperature and impact. These metal connectors may use a conventional fuse designed to blow when there is a abnormally high current between the cells, although use of a silver alloy is preferable as it increase conductivity. The metal connectors are integrated into the frame holding the battery cells. For each bank, there is a lower frame and an upper frame. The upper frame both holds the cells in place and contains the electrical connections and fusible links. When fusible links are used as the metal connectors they should not disconnect from the impact itself, but from the increased current from the damaged cells. Alternatively, the metal connectors can be designed to break upon impact of a predetermined level consistent with the occurrence of a crash, or can be designed to both act as a fuse in the event of excess current and to break upon impact. When impacted, the ceramic electrolytes are typically one of the first components to break, which allows the chemicals in the battery to fully mix and react, causing a spike in current and causing the fusible links to break. Fusible links would also provide overcharge protection because they would blow under an abnormally high current situation from an overcharge. Alternatively, a network of 2 mm copper buss bars may be placed on the top of each bank is so as to support the battery cells, provide the electrical connections between them, and act as the fusible link also.

The batteries are composed of individual cells rated between 2.5 and 3.5 volts and wired in series and parallel to generate 278 volts and the desired current. By having the connectors between the cells separate in an accident, each cell is isolated so that the risk of injury from an electrical shock is diminished. A person that receives an accidental shock from the battery with the cells disconnected would only experience the 2.5 to 3.5 volts of one cell, rather than the 278 volts of the entire battery pack. The BMI contains an electronically controlled inertia switch which disconnects the battery from the rest of the vehicle when there is an impact greater than approximately 5 mph. In addition, there are fusible links between the cells that are designed to automatically disconnect each cell from another in impacts greater than approximately 10 mph. The fusible links are designed to break in an impact of approximately the same force that would deploy the vehicle airbags and their design can be adjusted to change the amount of force that breaks the links. Using fusible links between the cells enhances the safety of the battery because if an accident causes an electrical leak from the battery, multiple cells will disconnect from each other, reducing the voltage of the electrical leak. Inertia switches are found in conventional automobiles to shut off the fuel pump in an accident, but have not been used on electric cars to isolate the battery during an accident to reduce the risk of an electrical shock for passengers and first responders.

A common use of electrical batteries is the automotive battery. Such batteries are subject to extreme conditions even under normal use, and even more extreme conditions in the event of a collision. While illustrated with respect to use in an electric vehicle, the invention may be applied to Sonick or to Nano batteries and to other batteries which are not based on lead or gel/acid. The system may be applied to those batteries when they are used, for example, on a go-cart, fork-lift, where they use a multitude of batteries.

Another aspect of the invention relates to regenerating a battery so as to increase the time between recharging, using a Turbo Fan based on Venturi Effect. This system can easily improve the regen system upwards to 30%. In our studies, we consider a speed of EV between 36-40 mph which is practically the speed used in majority cases: city, villages, and other roads. We consider that our system will be implemented in the front bumper of the vehicles. Or, at least, attached to that. We have three bumper possibilities which we tested for the following situations: 1. Immediately after the end of the bumper the speed is close to 50 mph. 2. At the end of the bumper the speed is 40 mph. 3. At the end of the tube which we designed with the length of 36 inches the speed varies between 55-60 mph. This is the solution which we chose.

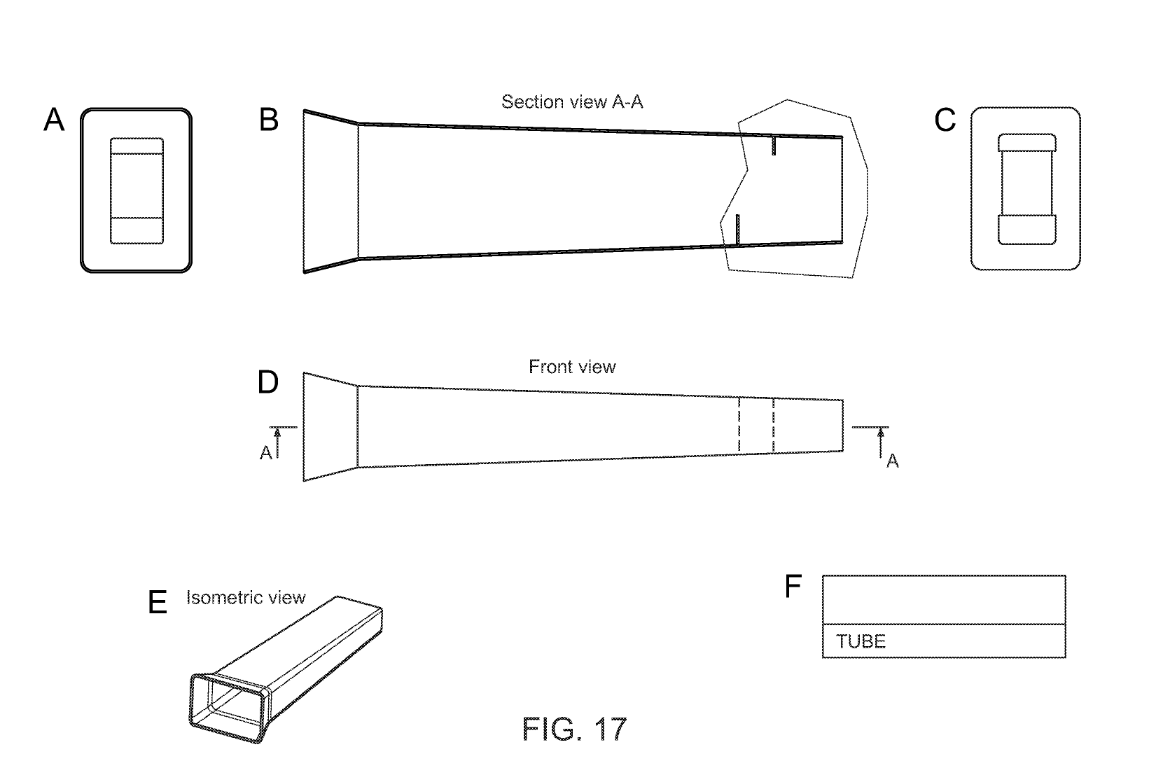

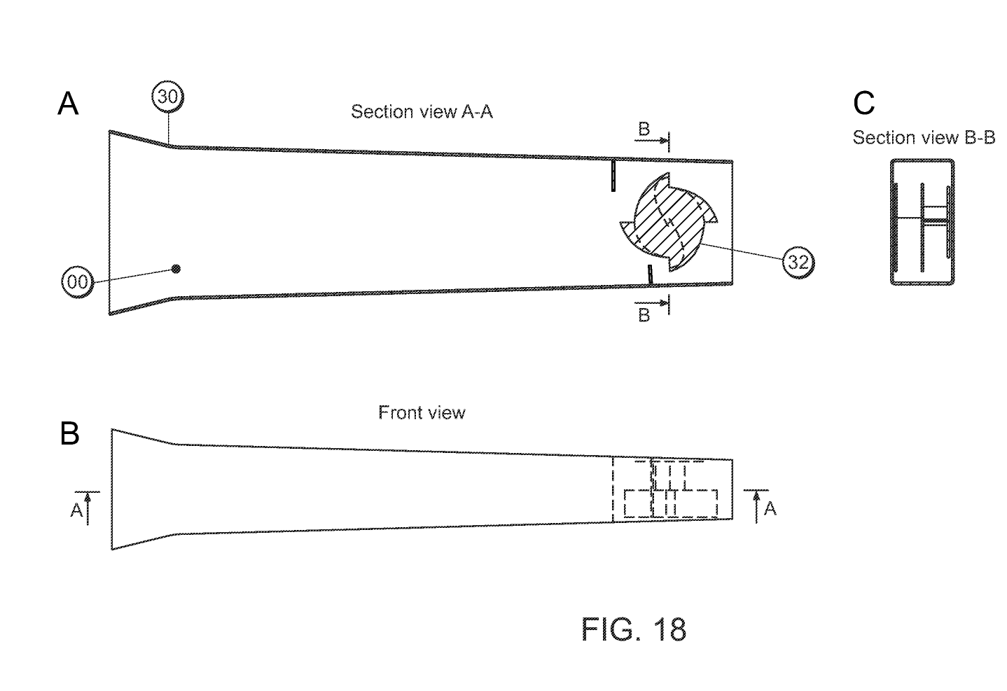

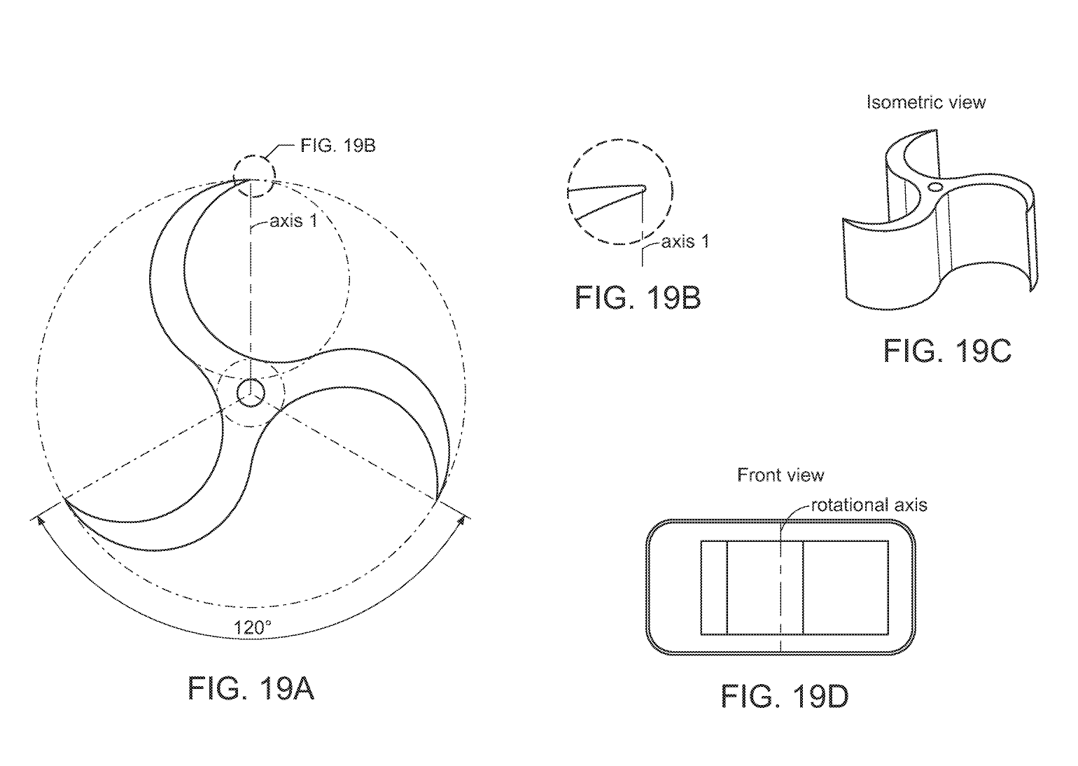

A suitable configuration of the venturi tube and fan, including details of the fan blades, is shown in FIGS. 17-19.

At the end of the tunnel is a turbo fan attached to a high torque electric motor which will produce regen electricity. A suitable high torque motor, with features for enhancing torque at reduce weight, is described below.

### ENHANCED TORQUE MOTOR

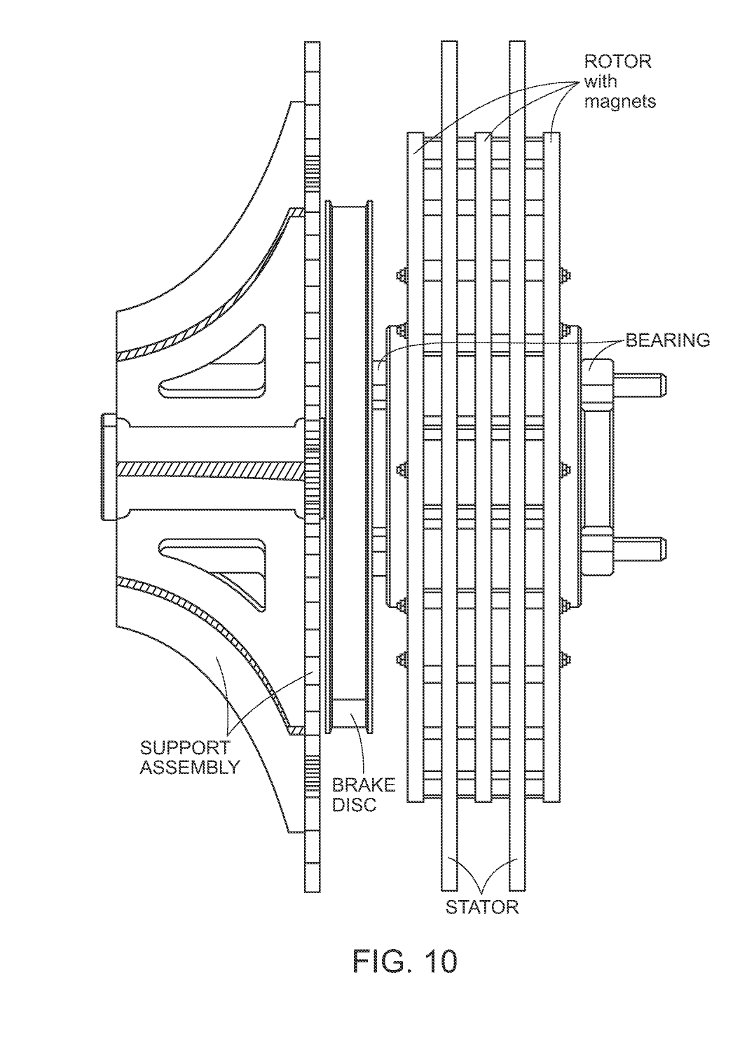

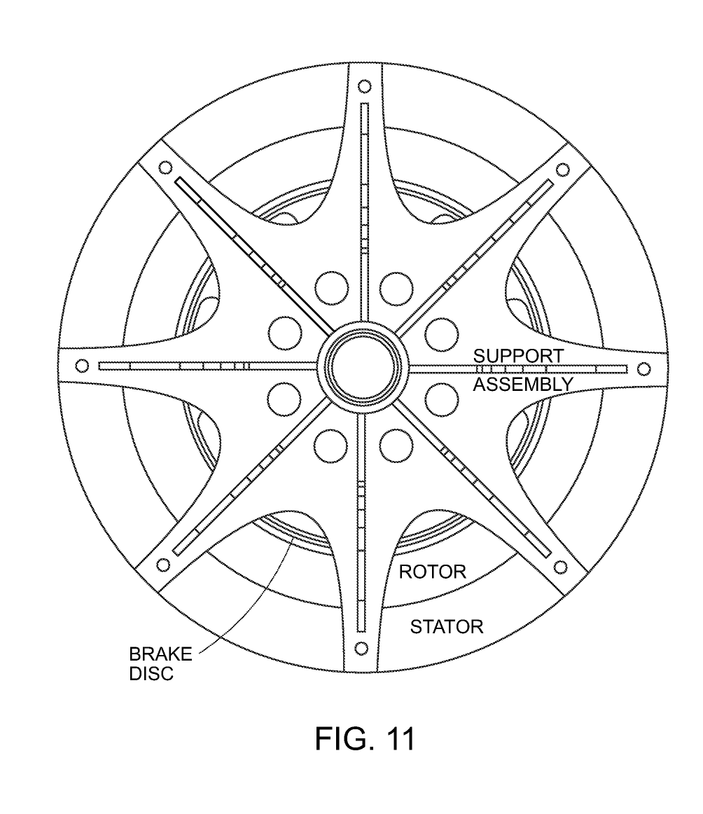

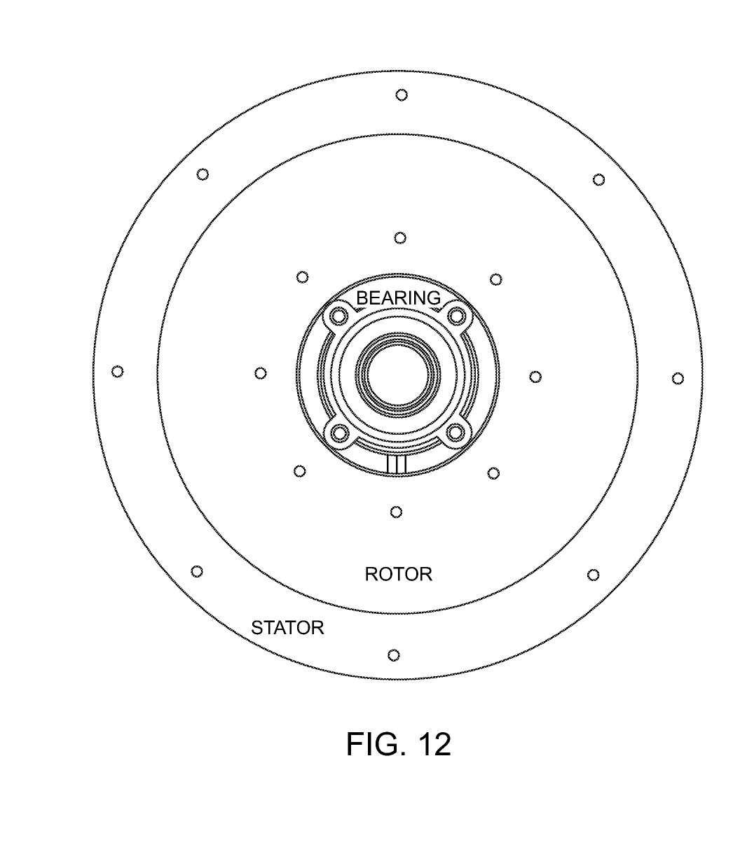

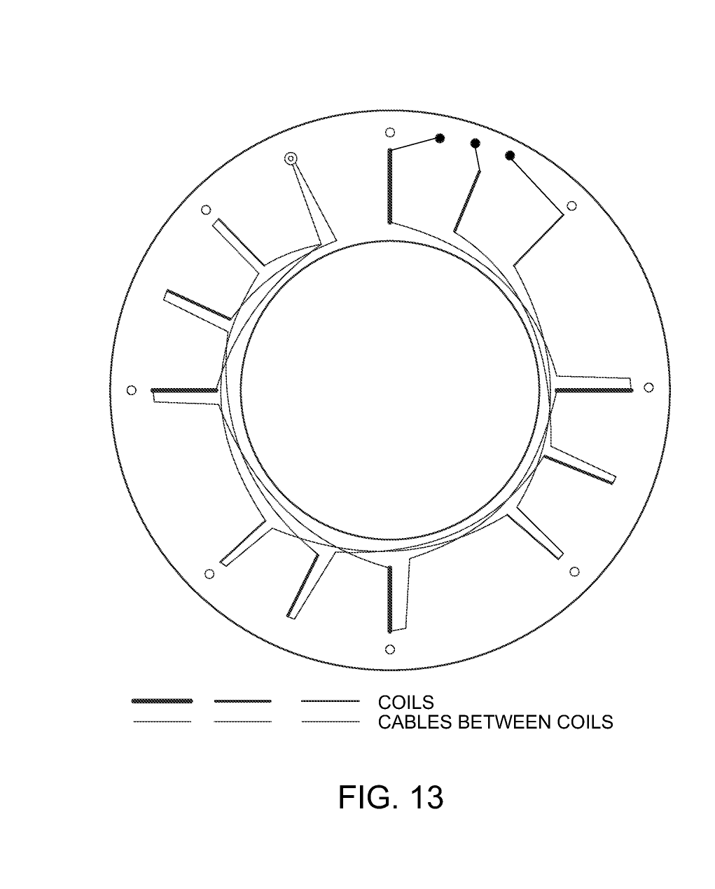

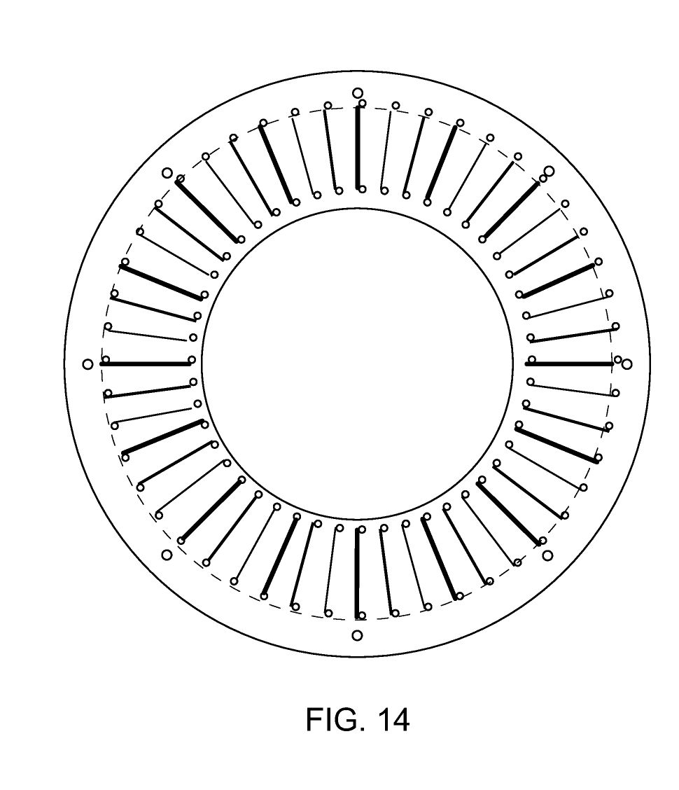

The enhanced torque motor is a dual stage electric motor that can be used as a motor or generator and provides significantly more torque than an electric motor of an equivalent size and weight. A side view of the motor is shown in FIG. 10 and FIGS. 11 and 12 contain a front and rear view. In the preferred embodiment, each stage has 48 magnets with 24 double poles mounted on rotors disposed on each side of the stators. The stators each contain 18 copper stators. The coils are wired in a 3-phase AC star configuration. The arrangement of the coils is shown in FIGS. 13 and 14. One advantage of this dual stage motor is that it can be used in a parallel connection with a threshold load from 50 rpm or in a series connection with a threshold load from 25 rpm.

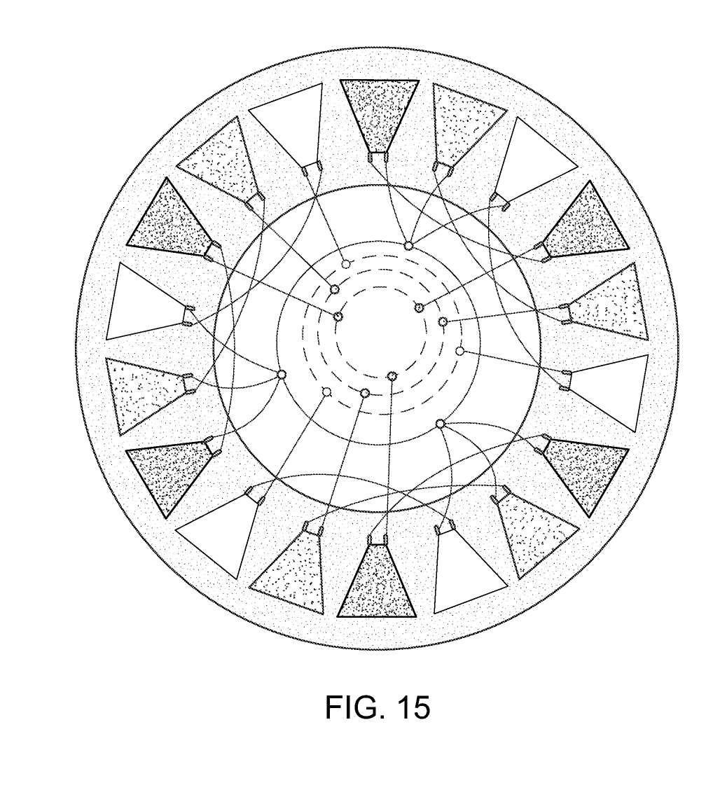

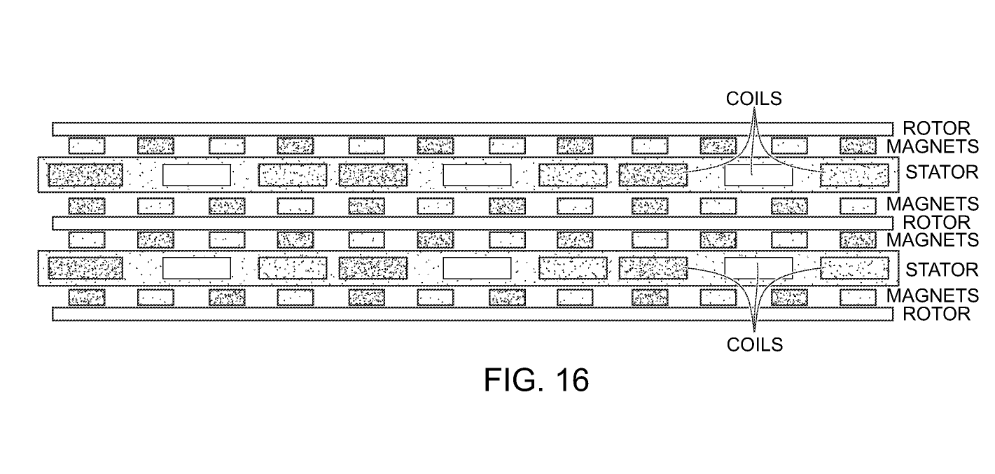

The arrangement of the magnets on the rotors is shown in FIG. 15. The magnets in the preferred embodiment are rectangular rather than trapezoidal. Using a trapezoidal shape can allow more magnetic material to be mounted on the rotor in larger applications, such as in a windmill. FIG. 16 shows the arrangement of the magnets on the rotors and the coils in the stators.

The rotors and stators are self-centering, which reduces the amount of friction by approximately 75%. Because of the self-centering feature of the improved motor, the motor does not put a load on the bearings when it is turning. The bearings evenly maintain the lateral distances between the rotors and stators while the motor is starting from a stop. Once the motor is rotating at more than approximately 30 to 40 rpm, the electromagnetic field between the rotors and stators cause the motor to self-center. When turning above this threshold speed to achieve self-centering, the motor puts only a nominal load on the shaft bearings, which in turn results in reduced friction.

The brake disc is similar to the improved enhanced torque motor and can be included within the motor, or as a standalone system. The brake disc is an electromagnetic brake and also uses laterally spaced rotors and stators with magnets arranged in the same method as on the motor. The brake disc acts an electromagnetic brake by reversing the polarity of the rotors and stators when compared to the motor. When acting as an electromagnetic brake, the brake disc can slow the shaft and generate electricity. The brake disc in the preferred embodiment for an automotive application is capable of generating 30% more electrical regeneration than the motor is able to consume. Compared to the motor, the tolerances between the rotors and stators, as well as the positioning of the magnets and windings are not as critical in the brake disc.

To allow the electromagnetic brake to be permanently mounted to the same shaft as the motor, the rotor freewheels (spins in only one direction) when the vehicle is accelerating or traveling at a constant speed. In this mode, the rotor and stator are both stationary so that the electromagnetic brake does not generate electricity or a braking force. When used to slow the vehicle and provide a braking force, the shaft engages the rotor and causes it to rotate relative to the stators, generating electricity and a braking force.

Inside the motor casing are also the inverters for the generator and motor. The inverter for the generator allows for electricity to only move in one direction—from the generator to the battery. The inverter for the motor allows electricity to flow in two directions—from the battery to the motor and vice versa.

The preferred embodiment uses an electromagnetic brake and a motor enclosed in the same housing, rather than a single motor used as a both a motor and generator. When the accelerator is depressed, the motor is receiving power to move the vehicle and the generator is freewheeling. When the brakes are depressed, the inverter for the electromagnetic brake creates a braking force, which slows the vehicle and generates electricity. The inverter for the motor also creates a braking force in the motor to slow the vehicle and generate electricity. By using a separate generator in addition to the motor's capacity to generate electricity when braking, the motor runs at a lower temperature which increases its reliability. The separate generator also increases the electric generation capacity of the vehicle so that energy can continue to be generated when the vehicle is slowing down rapidly, rather than shifting to the conventional friction braking system and losing the kinetic energy to heat.

In an automotive application, if coupled to a motor or axle, the brake disc could slow the vehicle and generate electricity to recharge the battery system. In a windmill application, the brake disc could be used to regulate the speed of the turbine during high wind conditions to keep the turbine spinning at a rate within its operating limits. The brake disc would allow this braking force regulating the rotation of the turbine to generate electricity, rather than be lost as heat if a traditional friction brake were used.

The use of plates for the rotors and stators, rather than an armature rotating within a housing, in combination with the powerful magnets used in this application, reduces the weight of the motor by 30%. The powerful magnets allow the rotor to be thinner and lighter. The resulting motor has three times as much torque as a conventional electric motor of the same weight. There is a reduced gyroscopic effect in this motor in comparison to conventional electric motors because of the reduction in shaft rpm and the reduced amount of rotating mass for a motor of comparable torque.

The magnets in the improved enhanced torque motor are preferably strong light magnets. A suitable choice is Neodymium, grade N50 rare earth magnets, each magnetized through its entire thickness and with the poles on the flats sides. The magnets are preferably homogeneously magnetized through the entire thickness to operate at maximum performance and each of the magnets is the same size and same strength. To operate properly, the magnets must be balanced magnetically and the rotor must be balanced for weight.

While the magnets used in the preferred embodiment are Neodymium, grade N50 rare earth magnets, it is appreciated that magnet technology is continually changing to produce higher power magnets. By increasing the magnetic flux through the use of more magnets or through stronger magnets will increase the torque of the motor. N50 grade magnets were chosen for their power and commercial availability, but other types of high power magnets could also be used in this motor design.

The motor runs at a low rpm and high torque, which allows a higher gear ratio and less power loss through the transmission. To obtain the same amount of torque from a high rpm conventional electric motor, the transmission would have to use a much lower gear ratio which would more power loss through the transmission. By using a high torque electric motor using high amperage and low revolutions per minute, the mileage per kilowatt of power used is increased.

To create a high torque motor, the enhanced torque motor uses the powerful permanent magnets to increase the magnetic flux and also uses a larger air gap between the stator and rotor. Compared to a conventional motor, this motor has a higher magnetic flux and a larger air gap.

All of the magnets are the same rectangular magnets. The angle is changed to adjust the flux for the motor and generator applications. The trapezoid shaped magnets are for large applications such as a windmill to increase the magnetic flux by increasing the amount of magnetic material on the rotor face.

The capacity for the generator and motor to generate electricity may be greater than the amount of electricity that the battery can receive. In this case, to allow the dual bank battery to make use of the regen capacity of the electromagnetic brake and the motor, the regen from these units is sent to a super capacitor to temporarily store and regulate the charge.

The enhanced torque motor was tested to the Environmental Protection Agency Fleet Utility Factors for Urban “City Driving” found in 40 C.F.R. §600.116-12, Table 1. The test vehicle was 3,120 pounds and used a conventional 28.1 kWh battery. The enhanced torque motor was installed to power the vehicle and the only regen system in use during the test was from the enhanced torque motor and from the ABS sensors. The test vehicle did not have the electromagnetic brake, the wind turbine generator or the stability control components of the regen system. Under these testing conditions, the vehicle had a range of 103 miles.

While a specific embodiment of the invention has been shown and described in detail with respect to a principal application in the field of vehicles, it is not limited to that field or type of battery. Rather, this is meant to illustrate the application of the principles of the invention, and it will be understood that the invention may be embodied otherwise without departing from such principles and that various modifications, alternate constructions, and equivalents will occur to those skilled in the art given the benefit of this disclosure.

What is claimed is:

1: A system for managing an electrical battery, comprising a multitude of cells (based on the size of the motor and the vehicle and needed performance) organized into 2 banks.
One of the conditions for the best performance is that all cells has to be perfectly calibrated and equal;
a monitoring system connected to each of said banks and to means for measuring the remaining charge in each of said banks;
means for selecting at least one bank from among the available banks as a bank which will provide electric power;
means for selecting at least one bank from among the available banks as a bank that will be recharged;
means for storing a preselected critical value;
means for causing a bank then providing power to be deselected as a bank providing power and selected as a bank to be recharged upon reaching the critical value; and
means for causing a bank then being recharged to a point above the critical value to be deselected as a bank to be recharged and selected as a bank providing power.

2: A battery cell comprising:
a negative electrode comprising NaCl crystals and
a positive electrode comprising zinc and nickel chloride.

3: A battery cell as in claim 2 wherein said NaCl crystals are uniform in size and jagged.

4: A battery as in claim 3 wherein said NaCl crystals are approximately 1.5×1.5×2 mm in size.

5: A battery cell as in claim 2 wherein said NaCl crystals contain approximately 80 micrograms of iodine per gram of NaCl.

6: A battery cell as in claim 2 wherein said positive electrode has a formula comprising 38% salt (NaCl), 15% zinc (Zn), 16% copper (Cu), 18% iron (Fe), 4% silver (Ag), 5% nickel (Ni), and 4% a combination of Sodium Aluminum Tetrachloride (NaAlCl4), Mica, Silica Amorphous (SiO2), and Sulfide by weight.

7: A battery cell having an electrode comprising:
38% salt (NaCl), 15% zinc (Zn), 16% copper (Cu), 18% iron (Fe), 4% silver (Ag), 5% nickel (Ni), and 4% a combination of Sodium Aluminum Tetrachloride (NaAlCl4), Mica, Silica Amorphous (SiO2), and Sulfide by weight.

8. (canceled)

9: A multiple-bank battery system comprising:
at least two banks of battery cells contained within two battery cases, each battery case having an “A” side and an opposite “B” side, with air channels formed within each battery case and each air channel terminating in two opposite apertures, one at said “A” side and one at said “B” side;
at least two cooling fans, each cooling fan connected either directly or via tubing to one of said apertures, disposed so that the air from one of said cooling fans is connected to an aperture at the “A” side and the air from the other cooling fan is connected to an aperture at the “B” side.

10: An enhanced torque motor comprising a rotor comprising a face plate attached to a spindle, said spindle passing through and free to rotate within a housing, said face plate having a series of magnets uniformly radially embedded therein, wherein said magnets are trapezoidal in shape when viewed in the axial direction.

11: An enhanced torque motor as in claim 10 wherein said magnets are Neodymium, grade N50 rare earth magnets, each homogeneously magnetized through its entire thickness and with the poles on the flats sides, each such magnet of substantially equal strength as each other such magnet.

12. (canceled)

13: An electric generator comprising:
a tunnel with a first opening and a second opening, where said first opening is larger than said second opening;
a propeller located adjacent to said second opening and rotating about an axle; and
an electric generator coupled to said axle.

14: The electric generator of claim 13 further comprising baffles between said first opening and said propeller, capable of directing air towards blades on said propeller.

15: The electric generator of claim 14 where said tunnel is mounted longitudinally on a vehicle with said first opening oriented in the direction of motion.
